(19) United States
(12) Patent Application Publication
(10) Pub. No.: US 2006/0060032 A1
(43) Pub. Date: Mar. 23, 2006

(54) Reset gear, method of use, and ratchet wrench utilizing said gear

(76) Inventor: David Baker, Fort Lawn, SC (US)

Correspondence Address: Schmeiser Olsen & Watts LLP, Suite 201, 3 Lear Jet Lane, Latham, NY, 12110, US

(21) Appl. No.: 10/946,015

(22) Filed: Sep. 21, 2004

(51) Int. Cl. B25B 13/46; B25B 17/00

(52) U.S. Cl. 81/57.39

(57) ABSTRACT

An assembly or reset gear device, typically used with ratchet wrenches, that has a body and at least two pawls pivotally attached to it and another part that has teeth that engage with the second pawl's teeth. The device that acts as an anvil has one body that is fixed to the head of a ratchet tool, while a second body can selectively rotate within the head. The second body also has two pawls, the second of which can selectively engage with the fixed first body. A pneumatic ratchet tool that employs such a device and a method of using the same is also disclosed.

### BACKGROUND OF INVENTION

1. Technical Field

This invention relates generally to the field of ratchet wrenches. More particularly, this invention provides for a reset gear that improves the reliability of various ratchet tools, such as pneumatic ratchet wrenches.

2. Related Art

In the field of pneumatic ratchet wrenches, as with tools, in general, greater reliability with the tool is desirous.

For example, it is desirable to have pneumatic ratchet wrenches without excessive slipping of the ratchet head, which frequently is due to worn out springs in the ratchet head. In order to fix the broken, or inefficient, wrench, the springs are typically replaced in the head. Alternatively, the existing ratchet head is replaced with an entirely new ratchet head. In either event, cost and time is expended in maintaining and/or fixing, the wrench.

Accordingly, there is a need in the field of ratchet wrenches, including pneumatic ratchet wrenches, for an improved ratchet head design.

### SUMMARY OF INVENTION

The present invention provides an apparatus for use with a ratchet wrench that offers improved reliability.

A first general aspect of the invention provides an anvil assembly, said assembly comprising:
a body, having a first pawl and a second pawl, each said first pawl and said second pawl pivotally mounted thereon; and
an element attached to said body, said element includes a plurality of teeth for engagement with a plurality of teeth on said second pawl.

A second general aspect of the invention provides an anvil device for use in a head of a ratchet tool, said device comprising:
a first body, fixedly attachable to said head;
a second body, configured to selectively rotate within said head, said second body further comprising a first pawl and a second pawl, wherein said second pawl is configured to selectively engage with said first body.

A third general aspect of the invention provides a pneumatic ratchet tool, said tool comprising:
a housing;
a motor, mounted within said housing;
a ratchet head, extending from said housing;
a first pawl, operatively attached within said ratchet head for engaging a first ratchet; and
a second pawl, operatively attached within said ratchet head for engaging with a second ratchet, wherein said motor is operatively attached to said first pawl and said second pawl.

A fourth general aspect of the invention provides a method comprising:
providing a body;
pivotally attaching a first pawl and a second pawl to said body; and
attaching an element to said body, said element includes a plurality of teeth for engagement with a plurality of teeth on said second pawl.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a top, perspective view of an embodiment of an anvil, in accordance with the present invention;

FIG. 2 depicts a top, perspective view of an embodiment of an anvil with a reset gear cover removed, in accordance with the present invention;

FIG. 3 depicts an exploded, top, perspective view of an embodiment of an anvil, in accordance with the present invention;

FIG. 4 depicts an exploded, top, perspective view of an anvil and a front portion of a pneumatic ratchet wrench, in accordance with the present invention; and

FIG. 5 depicts a side, elevation view of a pneumatic ratchet wrench, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

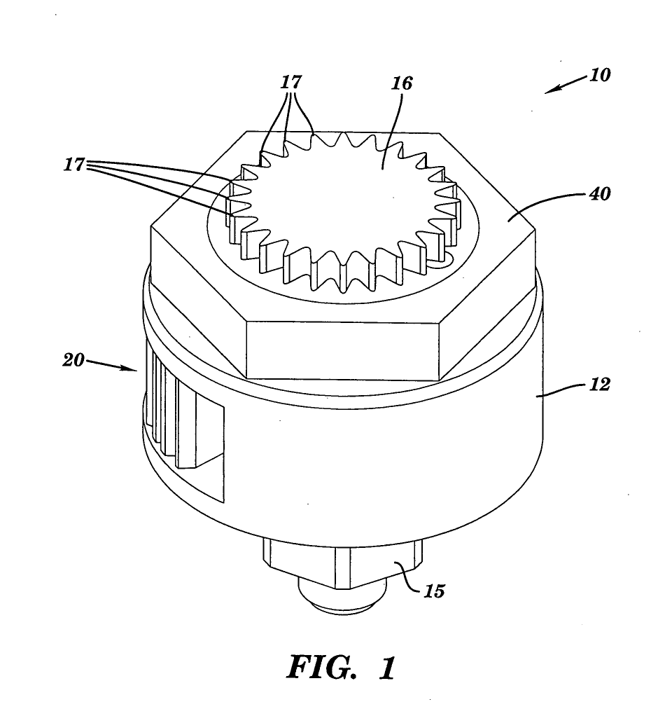

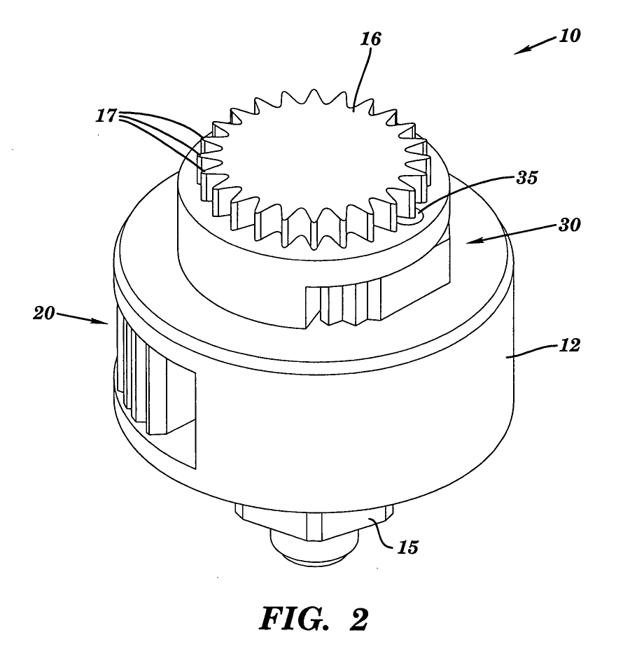

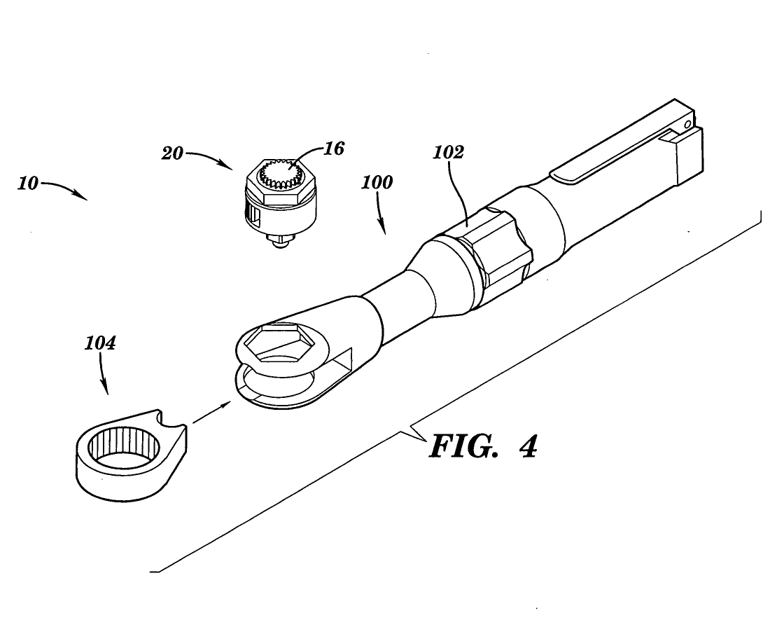

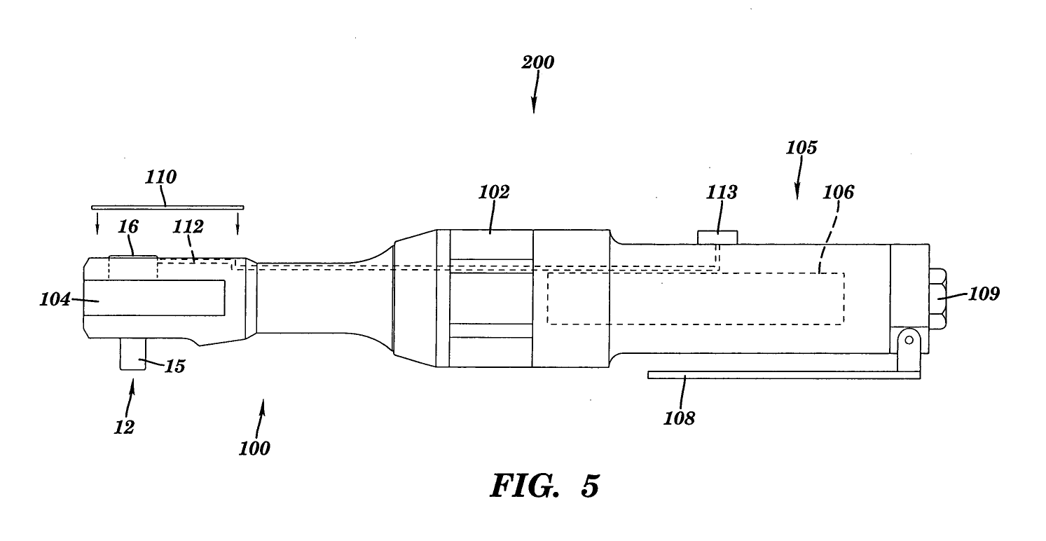

Referring to the drawings, FIG. 1 depicts one embodiment of an anvil assembly, hereinafter designated 10. The assembly, or device, 10 includes a plurality of parts including a first pawl 20 and a second pawl 30 (see e.g., FIG. 2). Each of the first and second pawls 20, 30 include a plurality of teeth 21, 31. The pawls 20, 30 are situated on, or within, a ratchet anvil body 12. At a first end of the body 12 is an anvil drive end 15. The drive end 15 may be any suitable shape and configuration to adapt to a workpiece (not shown) or receive a driving device (not shown) such as a socket, tool bit, screwdriver, and the like. At the second end of the body 12, opposite to the drive end 15 is an actuator 16, similarly with a plurality of teeth 17. A shift linkage 112 (See FIG. 5) engages with the teeth 17 of the actuator 16 in order to switch the direction of rotation of the anvil 12. Further located on the anvil body 12 is a gear cover 40, which covers the second pawl 30 (FIG. 2). The gear cover 40 has a hexagonally-shaped outer circumference. This shape allows the gear cover 40 to mate with a matching hexagonal shape recess (not shown) on a ratchet housing 100 (See e.g., FIG. 4) so that the gear cover 40 remains fixed and does not rotate along with the anvil body 12.

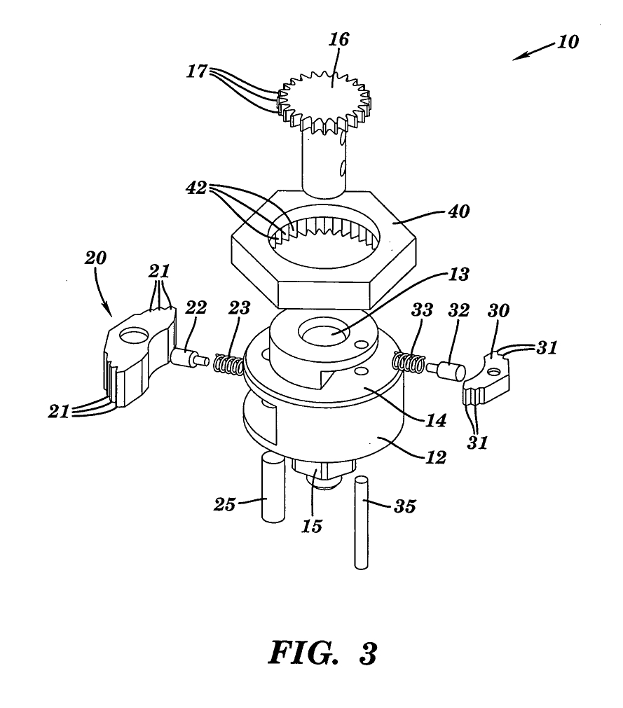

Alternatively, there are other embodiments that will allow the gear cover 40 to not rotate with the anvil body 12. For example, the gear cover 40 may have an appendage, or extension (not shown), that allows the gear cover 40 to be fixed to a portion of the ratchet housing 100 (FIG. 4) so that the gear cover 40 remains fixed and does not rotate with the anvil body 12. The appendage mates with a corresponding recess, hole, slot, or the like, on or within the ratchet housing 100. In still another embodiment (not shown), teeth 42 (FIG. 3) of the gear cover 40 can be integrated directly into the ratchet housing 100 itself, thereby rendering the gear cover 40 superfluous. The teeth 42, thus, provide a second ratchet to the invention. A first ratchet will be discussed below.

FIG. 2 shows the same view as in FIG. 1, yet with the reset gear cover 40 removed. In FIG. 2, one can readily see that the second pawl 30 is located so the teeth 31 can engage with the teeth 42 (See FIG. 3) on the internal surface of the reset gear cover 40 (i.e., the second ratchet). The second pawl 30 is rotatably attached to the anvil body 12 via a second pivot pin 35.

Finally, FIG. 3 most clearly shows an exploded view of the entire assembly 10. The assembly 10 includes an anvil body 12 that has an axial opening 13 in which resides the actuator 16. The axial opening 13 is coaxial with the aforementioned drive end 15. Rotatably attached to the anvil body 12 via a pin 25 resides the first pawl 20. The first pawl 20 resides within a recess in the anvil body 12. A first spring 23 and lock pin 22 allow the first pawl 20 to engage, via teeth 21, against teeth on the inside of a ratchet yoke 104 (FIG. 4), as is standard in the art. That is the teeth on the inside of the yoke 104 form the, aforementioned, first ratchet. The spring 23 provides a bias so that the pawl 20 stays engaged against the ratchet yoke 102 thereby preventing any slipping, or back (or “second” direction) rotation of the anvil 10, during rotation in a forward (or “first” direction) rotation. Depending on the direction of the rotation of the anvil body 12, the teeth 21 engage against the ratchet yoke 103 and prevent back rotation of the anvil body 12.

The anvil body 12 has a second pawl 30 that resides within a second recess on the anvil body 12. The second pawl 30 includes teeth 31. The second pawl 30 is rotatably attached, via a pin 35, to the anvil body 12. Further a lock pin 32 and spring 33 provide bias to the second pawl 30. The teeth 31 of the second pawl 30 engage and bear against the teeth 42 located on the reset gear cover 40. The reset gear cover 30 may rest upon a surface 14 of the anvil body 12. The first spring 23 and lock pin 22 of the first pawl 20 and the second spring 33 and locking pin 32 of the second pawl 30 may be opposed, as seen in FIG. 3.

An advantage of the second pawl 30 is that it provides additional anti-slipping capability to the assembly 10. This anti-slipping aspect is a further advantage when additional extension(s) and/or torsion/torque bars (not shown) are amended to the drive end 15 of the anvil 10. A disadvantage of adding these various extension(s) is that they may act as a type of torsion spring that may overcome the spring force of any springs providing locking bias to a pawl. Thus, frequently, when one adds an extension(s), a slipping occurs because the torsion, or spring, force of the extension(s) overcomes and exceeds the spring force of the pawl spring. This invention overcomes this shortcoming, amongst others. In part because the teeth 42 and cover 40 of the assembly 10 are fixed to the ratchet head, or ratchet housing 100 (FIG. 4), the invention provides enhanced and improved anti-slip capability. The teeth 31 of the second pawl 30 more positively engage with, or obtain purchase against, the teeth 42 of the cover 40. Thus, during rotation of the anvil assembly 10, the possibility of any of the aforementioned “back” slipping, or back rotation, is mitigated, or entirely removed.

Turning now to FIGS. 4 and 5, which show one embodiment of how the assembly 10 may be incorporated into a ratchet tool, in this case a pneumatic ratchet wrench 200. Note that, although the embodiments shown depict a pneumatic tool, the invention clearly can be utilized with other types of power tools (e.g., electric, etc.), as well as, hand (i.e., non-powered) ratchet tools.

A ratchet housing 100 that includes a clamp nut 102 for attachment to a tool housing 105 with a motor 106 therein also housing the anvil assembly 10 and a ratchet yoke 104 such as those known in the art. The teeth 21 of the first pawl 20 engage with the teeth on the ratchet yoke 104. The tool 200 further includes a trigger 108 that operates the motor 106. The housing 105 further includes a connection port 109 for fluid connection with a pressurized fluid source (not shown). A cover 110 is shown removed that covers and protects the actuator 16 and shift linkage 112 that is in communication with a manual forward reverse switch 113.

In general terms, the wrench 200 converts the flow and pressure of fluid (e.g., air) from an air source (not shown) in fluid communication with the connection port 109 to rotational energy at the anvil 12. The wrench 200 being employed to rotate workpieces (not shown) via the anvil 12, or an attachment (not shown) attached to the drive end 15 of the anvil 12.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. An anvil assembly, said assembly comprising:
a body, having a first pawl and a second pawl, each said first pawl and said second pawl pivotally mounted thereon; and
an element attached to said body, said element includes a plurality of teeth for engagement with a plurality of teeth on said second pawl.

2. The anvil assembly of claim 1, wherein said first pawl and said second pawl are not coplanar.

3. The anvil assembly of claim 1, wherein said element is coaxial with said body.

4. The anvil assembly of claim 1, wherein said first pawl and said second pawl are opposing each other.

5. The anvil assembly of claim 1, wherein said plurality of teeth of said element are on an interior surface of said element.

6. The anvil assembly of claim 1, wherein said element is rotatably attached to said body.

7. An anvil device for use in a head of a ratchet tool, said device comprising:
a first body, fixedly attachable to said head;
a second body, configured to selectively rotate within said head, said second body further comprising a first pawl and a second pawl, wherein said second pawl is configured to selectively engage with said first body.

8. The device of claim 7, wherein said first body includes a plurality of teeth for engagement with said second pawl.

9. The device of claim 7, wherein said first body is integrated with said head.

10. A pneumatic ratchet tool, said tool comprising:
a housing;
a motor, mounted within said housing;
a ratchet head, extending from said housing;
a first pawl, operatively attached within said ratchet head for engaging a first ratchet; and
a second pawl, operatively attached within said ratchet head for engaging with a second ratchet, wherein said motor is operatively attached to said first pawl and said second pawl.

11. A method comprising:
providing a body;
pivotally attaching a first pawl and a second pawl to said body; and
attaching an element to said body, said element includes a plurality of teeth for engagement with a plurality of teeth on said second pawl.
